(19) United States
(12) Patent Application Publication
(10) Pub. No.: US 2009/0280705 A1
(43) Pub. Date: Nov. 12, 2009

(54) Method and system for detecting a danger of drowning

(76) Inventors: Jurgen Puls, Poring (DE); Frank Richard Fassbender, Zorneding (DE)

Correspondence Address: WILHELM LAW SERVICE, S.C., 100 W LAWRENCE ST, THIRD FLOOR, APPLETON, WI, 54911, US

(21) Appl. No.: 12/387,690

(22) Filed: May 5, 2009

Related U.S. Application Data
(63) Continuation-in-part of application No. PCT/EP2007/009240, filed on Oct. 24, 2007.

(30) Foreign Application Priority Data
Nov. 6, 2006 (EP) EP 06023041.4

(51) Int. Cl. B63C 9/125; B63C 9/00; B63C 9/08; B63C 9/20; G01C 21/00; G08B 23/00

(52) U.S. Cl. 441/88; 441/80; 701/213; 340/573.6

(57) ABSTRACT

Method and system for detecting danger of drowning for a person in water. The method may comprise: determining whether the person is located in the water, measuring the pulse of the person, determining the position of the person, monitoring the capacity of an energy source on the person, transferring data from the person to a receiver on exceeding a boundary value of a pre-determined parameter, a gas chamber on the person is filled with gas and thereby buoyancy is generated, as well as optionally activating an alarm in the receiver. The method may further comprise measuring breathing frequency of the person, measuring pressure at the water depth of the person, measuring body position of the person, and comparing boundary value data and generated data to each other in an evaluation/signal unit as well as when the gas chamber is filled with gas and/or the alarm is activated.

### BACKGROUND OF THE INVENTION

1. Field of the Invention

The invention relates to a method for detecting a danger of drowning of a person in water and to a system for detecting a danger of drowning of a person in water.

2. Brief Description of Related Art

It is generally known that numerous persons fall victim to death by drowning each year only because they got into an emergency situation that was not observed by other persons. The danger of drowning exists in many places, for example in lakes, rivers or in the sea, in public swimming baths or in private swimming pools. In a lot of these cases a rescue would be easily possible, if the emergency situation was observed by other persons and the corresponding rescue action was initiated. Often a few minutes or even seconds decide over life and death of the person in danger.

Systems that can assist in saving a person from death by drowning are known per se. Such a system is described, for example, in US 2006/0019560 A1 having a water contact sensor, a pulse sensor, a gas providing device, an activating device for releasing a gas from the gas providing device, at least one gas chamber located on the body of the person using the system for receiving the gas from the gas providing device, a position determination device with regard to the person in the water, a transmitter for transferring condition and position data from the system to a distant receiver as well as at least one source of energy for the functional units of the system.

Although the known system is helpful in certain emergency situations, it only provides an insufficient protection against the death by drowning in a lot of other cases. In life-threatening situations persons react quite differently. Depending on situation and nature of the affected person the breathing frequency may change without an immediate significant change in the pulse frequency, for example. Then the latter is no reliable sign for a person being in a critical condition. In such a case there should be at least one other state parameter of the person simultaneously available for being able to detect the person's perilous situation quickly and clearly. For an optimal certitude there are still more parameters desirable, also concerning the risk that the transfer of the one or the other parameter does not work for any reason whatsoever.

For such systems functioning reliably in possibly all thinkable situations it should not only measure and transfer data of the bodily constitution of the person in danger to the place of surveillance. It would rather be desirable for the system also to provide such information which are independent of the bodily constitution of the person under supervision and nevertheless signal an existing danger for it.

Concerning these further requirements, the known systems, however, are still unsatisfactory.

Therefore, there is a need for an improvement of known methods and systems to that effect of being more reliable in the most diverse situations and, thus, reducing considerably the risk potential of drowning for many people. The certitude of thereby rescuing life would raise considerably to the same degree. Therein children are mostly concerned, who by lack of experience often do not recognize the gravity of a perilous situation quick enough, but also older persons whose perceptiveness and reaction is reduced due to age, which excludes an immediate action in an emergency situation, for example, an immediate faint.

### SUMMARY OF THE INVENTION

The present invention has been accomplished taking the above problems into consideration.

Therefore, it is desirable that the invention provide improved methods and systems for detecting drowning of a person in water.

According to an embodiment, the invention provides a method of detecting a danger of drowning for a person in water, wherein the method comprises: measuring at least one physiological parameter of the person and generating physiological condition data; measuring an orientation of a body of the person and generating body orientation data; determining a position of the person and generating position data; comparing the physiological condition data, the orientation data and the position data with corresponding preset boundary value data; activating an alarm based on the comparison; supplying, based on the comparison, a gas to a gas chamber for increasing a buoyancy of the person in the water.

According to a further embodiment, the invention provides a system for detecting a danger of drowning for a person in water, wherein the system comprises: a first sensor for measuring at least one physiological parameter of the person; a second sensor for measuring an orientation of a body of the person; an inflatable gas chamber and a gas supply, which can be activated to supply gas to the inflatable gas chamber; a third sensor for measuring a position of the person, and a control unit configured to activate the gas supply based on output signals provided by the first, second and third sensors.

### BRIEF DESCRIPTION OF THE DRAWINGS

The forgoing as well as other advantageous features of the invention will be more apparent from the following detailed description of exemplary embodiments of the invention with reference to the accompanying drawings. It is noted that not all possible embodiments of the present invention necessarily exhibit each and every, or any, of the advantages identified herein.

FIG. 1 displays a schematic illustration of a person wearing the single functional units of the system according to an exemplary embodiment on its body according to an embodiment of the present invention; and

FIG. 2 displays a flow chart explaining one exemplary embodiment of the method according to an embodiment of the present invention.

### DETAILED DESCRIPTION OF EXEMPLARY EMBODIMENTS

Although those of ordinary skill in the art will readily recognize many alternative embodiments, especially in light of the illustrations provided herein, this detailed description is exemplary of an embodiment of the present invention, the scope of which is limited only by the claims appended hereto.

According to embodiments of the invention, a method for detecting the danger of drowning for a person in the water comprises determining whether the person is located in the water; measuring a pulse frequency of the person; determining a position of the person; monitoring a capacity of at least one source of energy attached to the person; optionally transferring condition and position data from the person to a distant receiver; filling a gas chamber located on the body of the person with a gas when exceeding a preset boundary value of a measured parameter of the person, such that a sufficient buoyancy in the water is imparted; and activating an alarm in the distant receiver when exceeding the boundary value.

According to an exemplary embodiment, the method further comprises measuring a breathing frequency of the person.

According to a further exemplary embodiment, the method further comprises at least one of measuring a water pressure and measuring a sinking speed of the person.

According to an exemplary embodiment, the method further comprises measuring an orientation of the body of the person.

According to a further exemplary embodiment, the method further comprises comparing measured values with preset data using a control unit, supplying gas to the gas chamber, and activating an alarm.

According to a further exemplary embodiment, the breathing frequency is measured based on the abdominal and breast breathing of the person in danger.

According to a further exemplary embodiment, the method further comprises filling of the gas chamber with gas electrically or pyrotechnically activated.

According to a further exemplary embodiment, the determination of the position of the person in the water occurs by a GPS system (global positioning system).

According to a further exemplary embodiment, the transfer of data from the evaluation and signal unit to the distant receiver is carried out by means of a UHF or VHF transmitter.

According to a further exemplary embodiment, measurement of the body orientation of the person in the water is achieved by simultaneous application of two position sensors.

According to an exemplary embodiment of the invention, a system for detecting the danger of drowning for a person in the water comprises a water contact sensor; a pulse sensor; a gas providing device; an activating device for release of gas from the gas providing device; at least one gas chamber arranged on the body of the person for receiving the gas from the gas providing device; a position determination device for determining the position of the person; a transmitter for wireless transfer of condition and position data to a distant receiver; the distant receiver for receiving the data transferred by the transmitter; and at least one source of energy for supplying the functional units of the system with current.

According to a further exemplary embodiment, the system comprises a breathing sensor for measuring the breathing frequency of the person.

According to a further exemplary embodiment, the system comprises a water pressure sensor.

According to a further exemplary embodiment, the system comprises at least one position sensor for measuring the body position of the person.

According to a further exemplary embodiment, the system comprises a control unit for storage of preset boundary value data and of data which are transferred to this control unit as well as for evaluation of all these data and for transfer of signals to the activating device of the gas providing device and to the transmitter.

The system according to embodiments of the invention may have an advantage of recording a higher number of quantities to be measured signaling the danger of drowning for the corresponding person in the water than compared to the prior art. Therefore, the certitude for a rescue of the person in time is substantially raised. Additionally, quantities to be measured concerning body functions of the person are not only supervised, but independently there are also other physical quantities informing about a possible danger of the person monitored. On exceedance of preset boundary values of the said quantities, the system activates an alarm and enables the initiation of immediate aid actions for rescuing the person in danger.

The aforementioned quantities to be measured concerning the body functions may include the pulse frequency and the breathing frequency. The mentioned physical quantities can be independent from the body functions and are the water pressure in close proximity of the person and the body position of the person in the water.

A suitable water contact sensor is available on the market (for example, from the company Conrad Elektronik, Hirschau; item number 750201-62 as switch or item number 610373-62 as foil, each by omitting the joined alarm siren). The water contact sensor detects whether the corresponding person is located in the water. Its functional principle relies on an open circuit being closed due to contact with electrically conducting water.

A suitable pulse sensor is available on the market (for example, from the company Polar Electro GmbH Germany, Buettelborn; article description: S810i, heart rate monitor for scientific and medical purposes). The pulse sensor measures continuously the pulse frequency of the person.

A suitable gas supply is available on the market (for example, manufactured by the company SKS, article description: Air gun cartridge; supplied by the company HiBike, Kronberg i. Ts.; item number 84140071). The device is formed such that a predetermined amount of gas is released on its activation.

Furthermore, a suitable activating device for release of gas from the gas providing device includes an opening mechanism for the gas providing device. The opening mechanism comprises a melting body, for example, which is heated up by supply of electric energy and softens a membrane. By softening the membrane, it tears open and releases the gas from its reservoir, which then may stream into the gas chamber located on the body of the person.

The gas chamber can be integrated into a life jacket. Such life jackets are available on the market (for example, from the company Globetrotter, Bargkoppelstieg 10-14, 22145 Hamburg, model “Helly Hansen Kid Safe”).

The position determination device can be one available on the market (for example, from the company Garmin, place of business in the Federal Republic of Germany: GPS GmbH, Lochhamer Schlag 5a, 82166 Gräfelfing).

According to an embodiment, the device operates as a conventional GPS system and has a GPS receiver attached to the life jacket of the person, for example. The receiver detects continuously the actual position of the person in the water. The functional principle of the GPS system corresponds to that of known navigation devices for vehicles.

Furthermore, the transmitter can be one available on the market (for example, from the company Conrad Elektronik, Claus-Conrad-Str. 1, 92240 Hirschau). It serves to transfer critical data from the functional units of the system according to the invention as well as the position data most recently stored by the GPS receiver to a distant receiver, for example a mobile telephone or another reception device, by radio and to activate an alarm there. The transmitter may be a UHF or a VHF transmitter.

The source of energy may be any source of energy commonly known to the person skilled in the art for the purposes designated here; in exemplary embodiments it may be one or more batteries. In further exemplary embodiments, each technical unit of the system needing a source of energy is equipped with a dedicated battery.

A suitable breathing sensor is available on the market (for example, from the company SimTest-Bruno Zak, Simbach/Inn; article description: breathing belt). The sensor determines continuously whether the person in the water breathes and by which frequency it occurs.

A suitable water pressure sensor is available on the market (for example, from the company Conrad Elektronik, Claus-Conrad-Str. 1, 92240 Hirschau). It measures continuously the water depth in which the corresponding person is located and therewith also the sinking speed of the person when appropriate.

The position sensor can be one available on the market (for example, from the aforementioned company SimTest-Bruno Zak). The position sensor is attached to the body of the corresponding person or to one of its pieces of clothing and determines continuously the body position of the person in the water, in exemplary embodiments the upright position, the supine position, the sinistral position, the dexter position and the rectangular position with head down as well as corresponding intermediate positions.

The control unit provides a function of storage of data on a microchip. These data include data detected by the water contact sensor, the pulse sensor, the position determination device, the source of energy, the breathing sensor, the water pressure sensor and the sensor measuring the body orientation of the person in the water as well as being transferred to the control unit. Concerning the source of energy it is the matter of data, disclosing whether the supply of energy is still sufficient for a reliable function of the system. When this is not the case anymore the control unit activates an alarm signal for safety reasons.

Furthermore, boundary value data for the aforementioned functional units of the system according to the invention as well as combinations of such boundary value data (e.g. evolution pattern for the pulse frequency) are stored on the microchip. By means of a data processing program which can be developed by the person skilled in the art due to knowledge of the desired function, the data transferred to the control unit are continuously compared to corresponding boundary value data or combinations thereof. When there is a condition detected in which one or more of the boundary values are exceeded or their combination is typical for an emergency situation of the observed person, the evaluation and signal unit sends a signal to the activating device of the gas providing device and to the transmitter.

Thus, this activating device is activated and the gas providing device discharges the gas which is releasable there, while the transmitter transfers the current condition and position data of the person by radio to the distant receiver.

Alternatively, the transmitter may also transfer the condition and position data to the receiver in preset time intervals or continuously, even when there is no exceedance of boundary data present.

The quantities to be measured of three functional units of the system according to the invention are normally needed, this is a selection from the units water contact sensor, pulse sensor, breathing sensor, water pressure sensor and body orientation sensor. In exemplary embodiments, boundary value profiles are programmed in the evaluation and signal unit, each including a fourth quantity to be measured besides the three necessary quantities ensuring that the system still implements completely its function also in case of malfunction of one quantity to be measured.

Further exemplary embodiments of the system are specified in the dependent system claims.

The water contact sensor may be formed as a switch or a foil. The foil may comprise two separate contacts being bypassed when in contact with water. Current may flow through this conductor bridge such that the sensor operates.

The pulse sensor may be most easily and safely attached to a breast belt.

For cost reasons and in order to protect the environment, a suitable gas providing device can be a cartridge filled with compressed air.

According to an embodiment of the present invention, it may be advantageous when the activating device for release of the gas from the gas providing device has an opening mechanism which can be activated electrically or pyrotechnically.

According to an embodiment of the present invention, the gas chamber which can be filled with gas is integrated into a life jacket or another corresponding piece of clothing. Thereby, it may be advantageous to divide the gas chamber into several chambers or it can be designed in the form of tubes. In each case the gas chamber is dimensioned in such a way and located in the life jacket or the piece of clothing in such a manner that after the filling with the gas it imparts a defined buoyancy to the person in the water ensuring that it floats up to the water surface.

For practical operation of the system it can be advantageous when the breathing sensor is formed as a belt buckle on a breathing belt. In exemplary embodiments the sensor is cast into a pin of the buckle. The sensor may include a piezo element responding to the micro bending of the pin caused by breathing. The breathing sensor may detect both the abdominal breathing and the breast breathing. It is observable from the breathing frequency whether there exists an emergency situation for the person, which normally manifests itself in two different conditions. In the one case, there occurs an apnea during a faint or the drowning of the person. In the other case, a panic or an anxiety case leads to an extreme fast breathing or hackling.

According to an embodiment of the present invention, the water pressure sensor is formed for a continuous determination of the water depth and the sinking speed of the corresponding person. These quantities are independent from the measured quantities of the body condition of the person but likewise constitute important information concerning the extent of the danger for the person.

According to an embodiment of the present invention, two position sensors are used of which one is formed for attachment approximately at shoulder height and the other for attachment approximately at hip height of the person. The body positions detected by them can be output as different voltage levels in the range of 0 to 4 volts, for example.

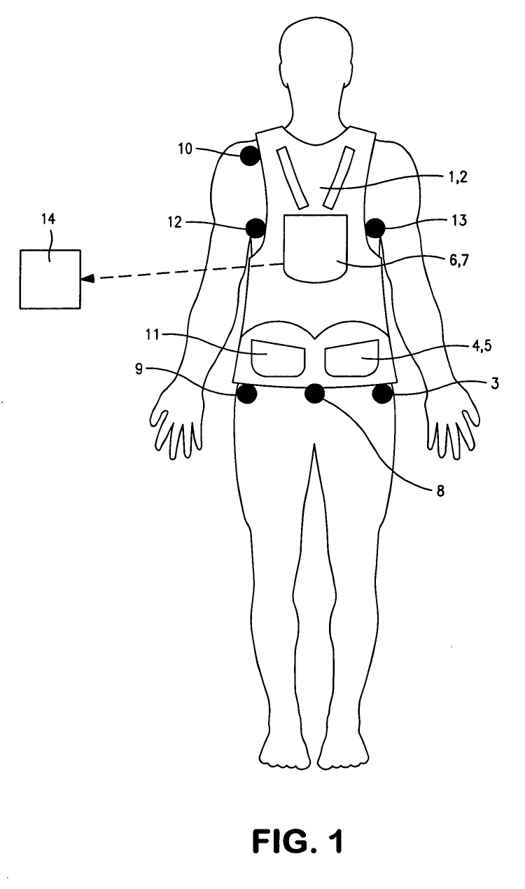

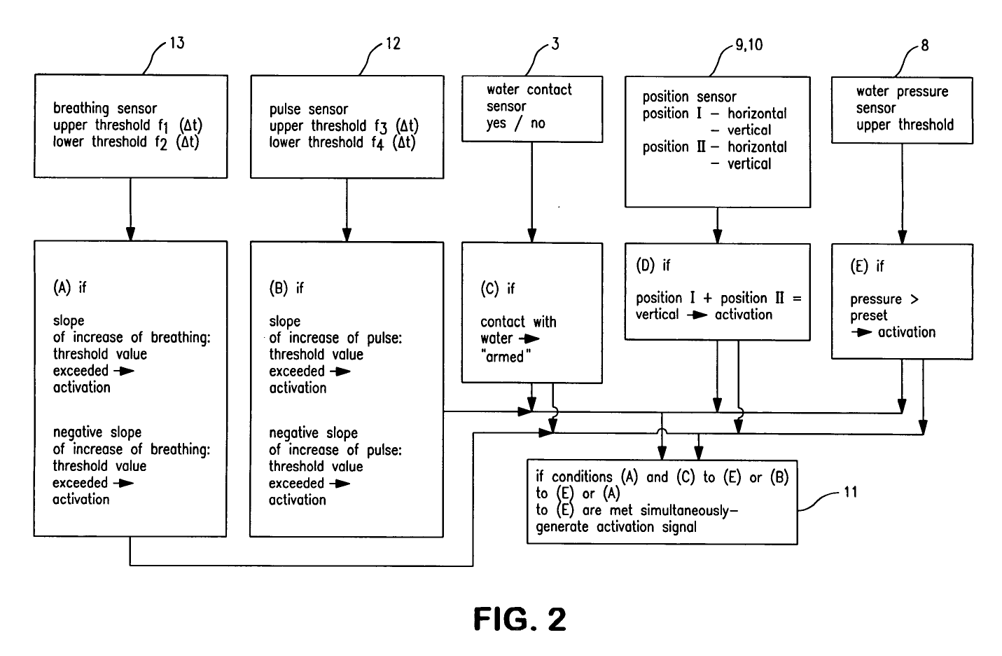

A particular embodiment of the invention will now be illustrated with reference to FIGS. 1 and 2. As shown in FIG. 1, a person using the system according to an exemplary embodiment wears a life jacket 1 with gas chambers 2 (which are not displayed in the figure). Attached to the life jacket 1 there is a water contact sensor 3, a gas providing device 4 with an activating device 5 (not displayed in the figure) for the release of a gas from the gas providing device 4, a position determination device 6 with an UHF transmitter 7 (not displayed in the figure), a water pressure sensor 8, a first position sensor 9 at the region of the hip of the person, and a second position sensor 10 at the region of the shoulder of the person as well as an evaluation and signal unit 11.

Furthermore, the person wears a pulse sensor 12 and a breathing sensor 13 at the region of the breast.

The system further comprises a receiver 14 located at a distant place for the reception of data being transferred by the transmitter 7.

As far as the different functional units of the system require a source of energy for their operation, there is a battery provided in each unit therein.

The procedure of the method according to an embodiment of the present invention for detecting the danger of drowning for the person equipped with the system according to an exemplary embodiment is explained by means of the flow chart according to FIG. 2 and is as follows:

The conditions (A), (B), (C), (D) and (E) are specified in FIG. 2.

The water contact sensor 3 detects whether the person is located in the water. When this is the case then the condition (C) is fulfilled which means that the system is “armed” and the functional units necessary for the observation of the person are activated.

The breathing sensor 13 measures continuously the breathing frequency, the pulse sensor 12 measures continuously the pulse frequency, each of the position sensors 9, 10 measure continuously whether the body position of the person is horizontal or vertical (position I measured by position sensor 9, position II measured by position sensor 10) and the pressure sensor 8 measures continuously the water pressure at hip height of the person.

The condition (A) is fulfilled if the breathing frequency exceeds an upper threshold value f₁ (Δt) or falls below a lower threshold value f₂ (Δt).

The condition (B) is fulfilled if the breathing frequency exceeds an upper threshold value f₃ (Δt) or falls below a lower threshold value f₄ (Δt).

The condition (D) is fulfilled if both position sensors 9, 10 each measure the vertical body position of the person.

The condition (E) is fulfilled if the pressure sensor 8 measures a pressure exceeding a preset boundary value.

When according to an exemplary embodiment of the method, there are the conditions (A) as well as (C), (D) and (E) or the conditions (B), (C), (D) and (E) fulfilled, which is detected by the evaluation and signal unit 11, then the unit activates corresponding signals. On the one side these are supplied to the transmitter 7 which activates via radio transmission an alarm at the receiver 14 and also displays there the current critical data according to the conditions (A), (B), (D) and (E). On the other side, the evaluation and signal unit 11 also sends a signal to the activating device 5, causing the activation of the opening mechanism of the gas providing device 4 and the gas streaming out from there enters the gas chamber 2 of the life jacket 1. Thus, this is inflated and imparts a sufficient large buoyancy on the person in the water, lifting it to the water surface.

Simultaneous to the activation of the signal to the transmitter 7, the current position of the person in the water is transferred to the receiver 14 by means of the position determination device 6.

Preferably, the receiver 14 is a mobile telephone equipped with a display or a similar mobile device. The position determination device 6 generates an arrow display as in a conventional navigation system of a vehicle and indicates the distance to the person in danger in meters. The arrow display is continuously directed to the person. Therefore, an helping person can reach rapidly the location of the person in the water and initiate corresponding rescue actions.

According to further exemplary embodiments, the method and the system may also be formed such that except the condition (C), only a selection of the remaining conditions (A), (B), (D) and (E) must be fulfilled in order to activate an alarm.

While the invention has been described with respect to certain exemplary embodiments thereof, it is evident that many alternatives, modifications and variations will be apparent to those skilled in the art. Accordingly, the exemplary embodiments of the invention set forth herein are intended to be illustrative and not limiting in any way. Various changes may be made without departing from the spirit and scope of the present invention as defined in the following claims.

What is claimed is:

1. A method of detecting a danger of drowning for a person in water, the method comprising:
measuring at least one physiological parameter of the person and generating physiological condition data;
measuring an orientation of a body of the person and generating body orientation data;
determining a position of the person and generating position data;
comparing the physiological condition data, the orientation data and the position data with corresponding preset boundary value data;
activating an alarm based on the comparison;
supplying, based on the comparison, a gas to a gas chamber for increasing a buoyancy of the person in the water.

2. The method according to claim 1, further comprising transmitting the physiological condition data, the orientation data and the position data to a receiver located at a distance from the person.

3. The method according to claim 2, wherein the comparing is performed by an evaluation and signal unit which is located at the distance from the person.

4. The method according to claim 2, wherein the transmitting is performed using one of a UHF and a VHF transmitter.

5. The method according to claim 1, wherein the at least one physiological parameter comprises a pulse frequency of the person and breathing frequency of the person.

6. The method according to claim 1, wherein the measuring of the at least one physiological parameter of the person comprises measuring of one out of an abdominal breathing of the person and a breast breathing of the person.

7. The method according to claim 1, further comprising measuring a water pressure.

8. The method according to claim 7, further comprising determining a sinking speed of the person in the water.

9. The method according to claim 1, further comprising monitoring a capacity of a source of energy attached to the person.

10. The method according to claim 1, wherein the determining of the position of the person is performed using a GPS system.

11. A system for detecting a danger of drowning for a person in water, the system comprising:
a first sensor for measuring at least one physiological parameter of the person;
a second sensor for measuring an orientation of a body of the person;
an inflatable gas chamber and a gas supply, which can be activated to supply gas to the inflatable gas chamber;
a third sensor for measuring a position of the person,
a control unit configured to activate the gas supply based on output signals provided by the first, second and third sensors.

12. The system according to claim 11, wherein the first, second and third sensors are attachable to the person in the water and wherein the control unit is located at a distance from the person outside of the water.

13. The system according to claim 12, further comprising a transmitter attachable to the person in the water and for transferring data to the receiver, the data being based on outputs of the first, second and third sensors.

14. The system according to claim 13, wherein the transmitter comprises a UHF and a VHF transmitter.

15. The system according to claim 11, further comprising a water contact sensor.

16. The system according claim 11, wherein the first sensor for measuring the at least one physiological parameter of the person comprises a pulse sensor and a breathing sensor.

17. The system according to claim 16, wherein the pulse sensor is attached to a breast belt.

18. The system according to claim 16, wherein the breathing sensor is integrated with a belt buckle of a breathing belt.

19. The system according to claim 11, wherein the inflatable gas chamber is integrated into a life jacket.

20. The system according to claim 11, wherein the third sensor for measuring the position of the person includes a GPS receiver.

21. The system according to claim 11, further comprising a water pressure sensor.

22. The system according to claim 11, wherein the second sensor for measuring an orientation of a body of the person comprises a first sensor portion attachable to a shoulder of the person, and a second sensor portion attachable to a hip of the person.
